(19) United States
(12) Patent Application Publication
(10) Pub. No.: US 2023/0012987 A1
(43) Pub. Date: Jan. 19, 2023

(54) OBTAINING A NAVIGATION PATH

(71) Applicant: Nokia Technologies Oy, Espoo (FI)

(72) Inventor: Yonggang WANG, Shanghai (CN)

(21) Appl. No.: 17/785,255

(22) PCT Filed: Jan. 3, 2020
(86) PCT No.: PCT/CN2020/070220

§ 371 Date: Jun. 14, 2022

(51) Int. Cl. G01C 21/34; G05D 1/02; G08G 1/16

(52) U.S. Cl. CPC G01C 21/3407; G05D 1/0212; G05D 1/0238; G08G 1/16

(57) ABSTRACT

An apparatus comprises means for: obtaining a navigation path (2) between two locations (4, 6) which are separated by an obstacle (8), the navigation path (2) comprising an original vertex (10); modifying the navigation path (2) to comprise a displaced vertex (12), the displaced vertex (12) being displaced from the original vertex (10) in a direction away from a part of the obstacle (8) which is nearest to the original vertex (10); and smoothing a section of the navigation path (2) which passes via the displaced vertex (12). The smoothing of the section forms a curved path section (16) in the navigation path (2). The curved path section (16) comes no closer to the obstacle (8) than the original vertex (10).

### TECHNOLOGICAL FIELD

Embodiments of the present disclosure relate to obtaining a navigation path. Some relate to obtaining a navigation path in which a section is smoothed to form a curved path section around an obstacle.

### BACKGROUND

Planning a navigation path involves finding a sequence of desired positions that enable movement between two locations, avoiding collision with obstacles. The shortest navigation path, in terms of length, between two locations while avoiding collision with obstacles can be found.

Navigation paths can be provided to control the movement of a vehicle autonomously or to support control of movement of a vehicle by a user.

### BRIEF SUMMARY

According to various, but not necessarily all, embodiments there is provided an apparatus comprising means for: obtaining a navigation path between two locations which are separated by an obstacle, the navigation path comprising an original vertex; modifying the navigation path to comprise a displaced vertex, the displaced vertex being displaced from the original vertex in a direction away from a part of the obstacle which is nearest to the original vertex; and smoothing a section of the navigation path which passes via the displaced vertex. The smoothing of the section forms a curved path section in the navigation path. The curved path section comes no closer to the obstacle than the original vertex.

According to various, but not necessarily all, embodiments there is provided an apparatus comprising: at least one processor; and at least one memory including computer program code, the at least one memory and the computer program code configured to, with the at least one processor, cause the apparatus at least to perform: obtaining a navigation path between two locations which are separated by an obstacle, the navigation path comprising an original vertex; modifying the navigation path to comprise a displaced vertex, the displaced vertex being displaced from the original vertex in a direction away from a part of the obstacle which is nearest to the original vertex; and smoothing a section of the navigation path which passes via the displaced vertex. The smoothing of the section forms a curved path section in the navigation path. The curved path section comes no closer to the obstacle than the original vertex.

According to various, but not necessarily all, embodiments there is provided a method comprising: obtaining a navigation path between two locations which are separated by an obstacle, the navigation path comprising an original vertex; modifying the navigation path to comprise a displaced vertex, the displaced vertex being displaced from the original vertex in a direction away from a part of the obstacle which is nearest to the original vertex; and smoothing a section of the navigation path which passes via the displaced vertex. The smoothing of the section forms a curved path section in the navigation path. The curved path section comes no closer to the obstacle than the original vertex.

According to various, but not necessarily all, embodiments there is provided a computer program that, when run on a computer, performs: causing obtaining of a navigation path between two locations which are separated by an obstacle, the navigation path comprising an original vertex; causing modifying of the navigation path to comprise a displaced vertex, the displaced vertex being displaced from the original vertex in a direction away from a part of the obstacle which is nearest to the original vertex; and causing smoothing of a section of the navigation path which passes via the displaced vertex. The smoothing of the section forms a curved path section in the navigation path. The curved path section comes no closer to the obstacle than the original vertex.

According to various, but not necessarily all, embodiments there is provided a non-transitory computer readable medium/computer product/machine readable medium, comprising instructions stored thereon for performing at least the following: causing obtaining of a navigation path between two locations which are separated by an obstacle, the navigation path comprising an original vertex; causing modifying of the navigation path to comprise a displaced vertex, the displaced vertex being displaced from the original vertex in a direction away from a part of the obstacle which is nearest to the original vertex; and causing smoothing of a section of the navigation path which passes via the displaced vertex. The smoothing of the section forms a curved path section in the navigation path. The curved path section comes no closer to the obstacle than the original vertex.

According to various, but not necessarily all, embodiments there is provided examples as claimed in the appended claims.

The following portion of this ‘Brief Summary’ section, describes various features that may be features of any of the embodiments described in the foregoing portion of the ‘Brief Summary’ section. The description of a function should additionally be considered to also disclose any means suitable for performing that function.

The curved path section can make its closest approach to the obstacle at a position of the original vertex.

The navigation path can comprise a sequence of desired positions which enable a continuous motion that connects the two locations.

Prior to modification, the navigation path can comprise a substantially shortest path between the two location while avoiding collision with the obstacle.

A distance between the displaced vertex and the part of the obstacle which is nearest to the original vertex can be greater than a distance between the original vertex and the part of the obstacle which is nearest to the original vertex. The original vertex can be intermediate to the displaced vertex and the part of the obstacle which is nearest to the original vertex.

Smoothing the section of the navigation path which passes via the displaced vertex can comprise converting the section into three or more segments, adjacent segments being angled relative to each other, the reflex angle between adjacent segments being smaller than the reflex angle of the navigation path over the displaced vertex.

The curved path section can comprise the three or more segments.

The magnitude of the displacement of the displaced vertex from the original vertex can be dependent on a turn angle and on linear and angular speed constraints for the turn angle.

The navigation path, prior to modification, can comprise a plurality of original vertices.

The navigation path can be modified to comprise a quantity of displaced vertices which is less than the plurality of original vertices.

The navigation path can be modified to comprise a plurality of displaced vertices, ones of the plurality of displaced vertices being displaced from respective ones of the plurality of original vertices.

A first of the plurality of displaced vertices can be displaced from a first of the plurality of original vertices in a direction away from a part of the obstacle which is nearest to the first of the plurality of original vertices.

A second of the plurality of displaced vertices can be displaced from a second of the plurality of original vertices in a direction away from a part of the obstacle which is nearest to the second of the plurality of original vertices.

A section of the navigation path which passes via both the first and second of the plurality of displaced vertices can be smoothed in order to form the curved path section in the navigation path.

The displaced vertex can be displaced along an angle bisector of a section of the navigation path over the original vertex.

The section of the navigation path which passes via the displaced vertex can begin at a first waypoint and end at a second waypoint.

The first waypoint can be at an intersection of the navigation path leading to the displaced vertex with a perpendicular to the angle bisector of the section of the navigation path over the original vertex.

The second waypoint can be at an intersection of the navigation path leading from the displaced vertex with the perpendicular to the angle bisector of the section of the navigation path over the original vertex.

The perpendicular to the angle bisector can intersect the angle bisector at a displacement from the original vertex which is equal and opposite to the displacement of the displaced vertex from the original vertex.

The displaced vertex can be displaced in a direction such that, when the section of the navigation path which passes via the displaced vertex is smoothed, the curved path section avoids a collision with a second obstacle.

According to various, but not necessarily all, embodiments there is provided a vehicle control system comprising one of the aforementioned apparatus, the navigation path being for controlling motion of a vehicle.

According to various, but not necessarily all, embodiments there is provided a vehicle comprising the vehicle control system.

### BRIEF DESCRIPTION

Some examples will now be described with reference to the accompanying drawings in which:

FIG. 1 shows an example of a method as described herein;

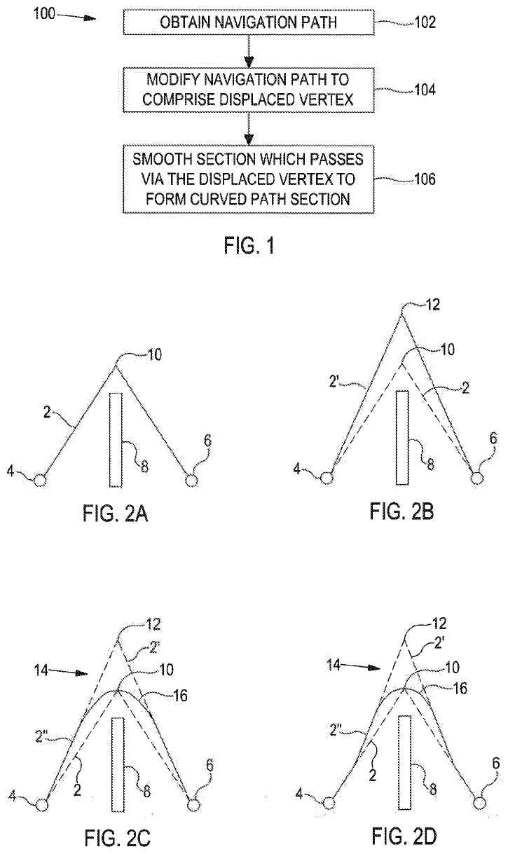

FIGS. 2A-D shows examples of navigation paths as described herein;

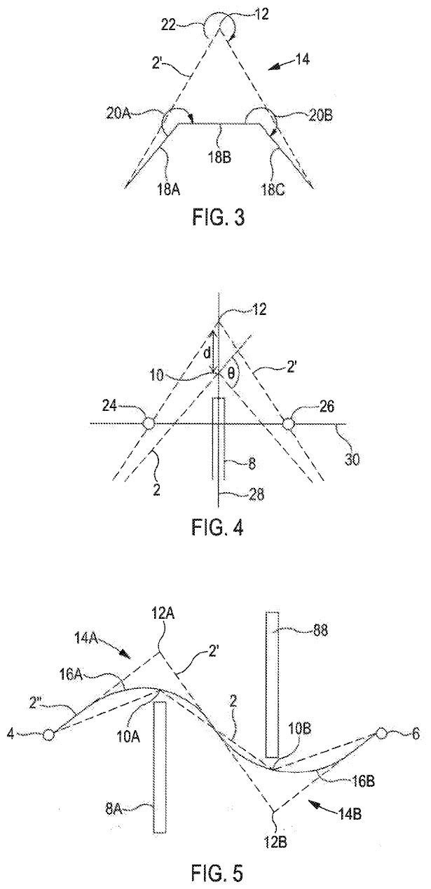

FIG. 3 shows an example of a navigation path as described herein;

FIG. 4 shows an example of a navigation path as described herein;

FIG. 5 shows an example of a navigation path as described herein;

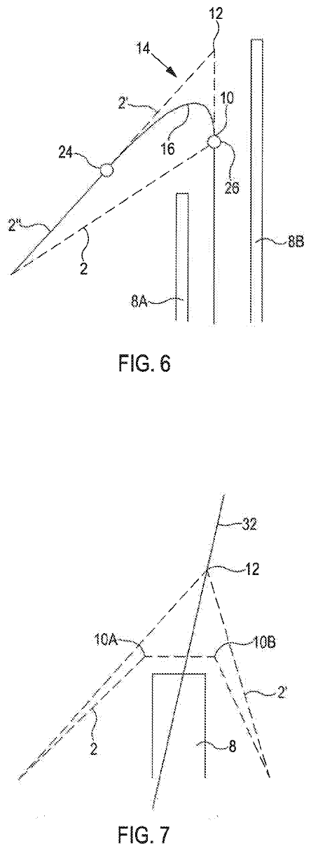

FIG. 6 shows an example of a navigation path as described herein;

FIG. 7 shows an example of a navigation path as described herein;

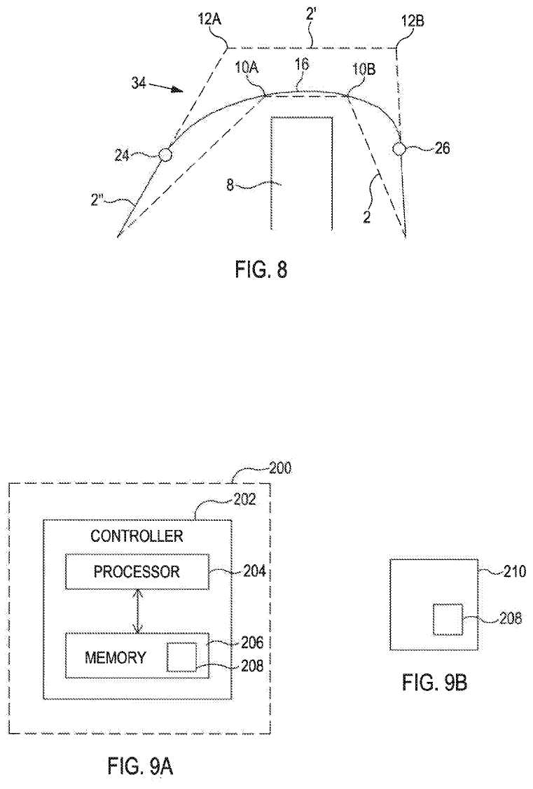

FIG. 8 shows an example of a navigation path as described herein;

FIG. 9A shows an example of an apparatus as described herein;

FIG. 9B shows an example of a delivery mechanism as described herein;

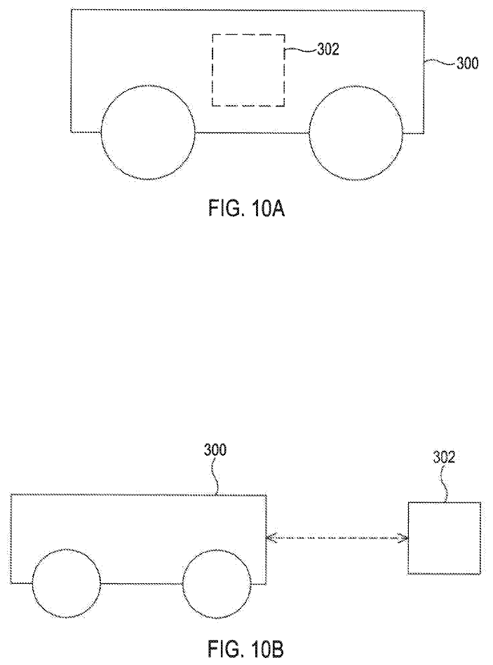

FIG. 10A shows an example of a vehicle control system as described herein; and

FIG. 10B shows an example of a vehicle as described herein.

### DETAILED DESCRIPTION

FIG. 1 illustrates an example of a method 100. The method 100 is for planning a navigation path. The navigation path may be for a vehicle and can be used to control motion of the vehicle autonomously or to assist in controlling motion of the vehicle by a user.

At block 102, the method 100 comprises obtaining a navigation path. FIG. 2A illustrates an example of the navigation path 2. The navigation path 2 is between at least two locations 4, 6 which are separated by at least one obstacle 8. The navigation path 2 comprises an original vertex 10. At this original vertex 10 the orientation of the navigation path 2 changes. The original vertex 10 can represent a point at which the navigation path 2 turns towards the second location 6, having proceeded prior to this point in a direction from a first location 4 which avoids collision with the obstacle 8.

The two locations 4, 6 can be specified in two- or three-dimensional space.

The navigation path 2 can comprise a sequence of desired positions which enable a continuous motion that connects the two locations 4, 6. The sequence of desired positions enables a continuous motion that connects to two locations 4, 6 while avoiding collision with the obstacle 8. The navigation path can also comprise corresponding desired velocities and accelerations at the desired positions.

In some examples, the navigation path 2 comprises a shortest path or a substantially shortest path between the two locations 4, 6 which avoids collision with the obstacle 8. The navigation path 2 comprises desired positions in a space which is not occupied by the obstacle 8 (the obstacle space). The obstacle space may also comprise positions in which a vehicle, for which the navigation path 2 (or a modification thereof) is to be provided, would contact the obstacle 8. Thus, the original vertex 10 can comprise a position in which the vehicle would be substantially as close to the obstacle 8 as possible without being in contact with the obstacle 8.

The shortest path can be understood in relation to the dimensions of a vehicle which is to be provided the navigation path 2 (or modification thereof). That is, the navigation path 2 may be a shortest path in which no part of a vehicle for which the path is to be provided would come into contact with the obstacle 8.

The substantially shortest path can be understood in relation to the dimensions of a vehicle which is to be provided the navigation path 2 (or modification thereof) and in relation to a safety threshold around the obstacle 8. That is, the navigation path 2 may be a shortest path in which no part of a vehicle for which the path is to be provided would come closer to the obstacle 8 than a safety threshold around the obstacle 8.

The navigation path 2 can be obtained by observation of a scene comprising the two locations 4, 6 and the at least one obstacle 8 between them (for example, using a camera or other sensors), processing of the observed scene to extract salient features such as the position of the obstacle 8 relative to the two location 4, 6 (for example using computer vision), and calculation of the navigation path 2 based on the salient features.

Alternatively, the block 102 of method 100 can comprise receiving data of the observed scene and subsequently performing the processing and calculation, or receiving data of the salient features and subsequently performing the calculation, or receiving the calculated navigation path 2.

The navigation path 2 can be calculated by the Dijkstra algorithm or the A* algorithm or any other suitable global path planning algorithm. A navigation path initially calculated using the A* algorithm can be smoothed by the Floyd algorithm to provide the navigation path 2 having the original vertex 10. The Floyd algorithm first merges collinear nodes in the path array returned by the A* algorithm and secondly removes redundant vertices, as far as possible.

It is also to be appreciated that the navigation path 2 can connect three or more specified locations rather than simply two locations 4, 6.

As shown in FIG. 2A, the navigation path 2 may require that a vehicle turns on a fixed point, for example at the original vertex 10. This may require a vehicle to stop and then make a sharp turn which can affects the continuity of motion of the vehicle and stability of the vehicle, or may require the vehicle to comprise omnidirectional wheels, differential wheels, Mecanum wheels, or the like. Where the navigation path 2 comprises a plurality of original vertices 10 (such as the examples shown in FIGS. 5, 7, and 8 below), the vehicle may be required to stop a plurality of times while following the path. The following blocks in the method 100 address these problems.

At block 104 in FIG. 1, the method 100 comprises modifying the navigation path 2. FIG. 2B illustrates an example in which the navigation path 2 is modified. In this and subsequent figures, the navigation path obtained in block 102 is referenced as 2 and the navigation path resulting from the modification in block 104 is referenced as 2′. The navigation path 2′ comprises a displaced vertex 12. The displaced vertex 12 is displaced from the original vertex 10 in a direction away from a part of the obstacle 8 which is nearest to the original vertex 10.

As shown in FIG. 2B, the navigation path 2′ comprises a line segment between the first location 4 and the displaced vertex 12 and a line segment between the displaced vertex 12 and the second location 6. In other examples the navigation path 2′ may comprise a line segment from the first location 4 leading towards, but not reaching, the original vertex 10, a line segment diverging from this initial heading and leading towards and reaching the displaced vertex 12, a line segment from the displaced vertex 1 to a point lying on the original navigation path 2 between the original vertex 10 and the second location 6, and a line segment from this point to the second location 6.

The distance between the displaced vertex 12 and the part of the obstacle 8 which is nearest the original vertex 10 may be greater than the distance between the original vertex 10 and the part of the obstacle 8 which is nearest to the original vertex 10. The original vertex 10 is intermediate to the displaced vertex 12 and the part of the obstacle 8 which is nearest to the original vertex 10, though may not lie directly on a line between the two.

At block 106 shown in FIG. 1, the method 100 comprises smoothing a section 14 of the navigation path 2′ which passes via the displaced vertex 12. Since the original vertex 10 is a point of close approach to the obstacle 8, smoothing the navigation path 2 which passes via the original vertex 10 could lead to collision with the obstacle 8. Therefore, the method 100 comprises the displacement of the original vertex 10 to the displaced vertex 12 (in block 104) so as to provide sufficient space on the interior of the navigation path 2′ for smoothing the navigation path 2′ in a manner which still avoids collision with the obstacle 8.

FIG. 2C shows an example of the smoothing. In this and subsequent figures, the navigation path resulting from the smoothing in block 106 is referenced as 2″. The smoothing of the section 14 of the navigation path 2′ forms a curved path section 16 in the navigation path 2″. The curved path section 16 comes no closer to the obstacle 8 than the original vertex 10. In some examples the curved path section 16 makes its closest approach to the obstacle 8 at a position of the original vertex 10.

The smoothing may not be applied to the whole of the navigation path 2′. For example, the smoothing may be applied to the section 14 of the navigation path 2′ which passes via the displaced vertex 12 and may not be applied to at least some other sections of the navigation path 2′. As a result, the navigation path 2″ resulting from the smoothing in block 106 can share some sections (line segments) with the navigation path 2′ resulting from the modification in block 104. For example, the navigation path 2″ resulting from the smoothing in block 106 can comprise line segments which have a heading towards or away from the displaced vertex 12 and which can form a linking section between waypoints in the navigation path 2 obtained in block 102 and the curved path section 16 in the navigation path 16 which results from the smoothing in block 106. These linking sections may be comprised in the navigation path 2″.

In some examples, such as shown in FIG. 2C, the navigation path 2″ follows the navigation path 2′ in heading towards the displaced vertex 12 until diverging onto the curved path section 16 at the beginning of the section 14 of the navigation path 2′ and then, when the curved path section 16 is heading in a direction directly away from the displaced vertex 12, the navigation path 2″ straightens and follows the same path as the navigation path 2′.

In some examples, such as shown in FIG. 2D, the navigation path 2″ can proceed from the first location 4 towards the original vertex 10 (following the same or substantially the same path as the navigation path 2 obtained in block 102) until diverging into a direction towards the displaced vertex 12. The navigation path 2″ can then proceed from the point of divergence towards the displaced vertex 12 (following the same or substantially the same path as the navigation path 2′ resulting from the modification in block 104) until diverging onto the curved path section 16 at the beginning of the section 14 of the navigation path 2′. The navigation path 2″ can then proceed from the beginning of section 14 along the curved path section 16 until heading in a direction directly away from the displaced vertex 12. At this point, the navigation path 2″ can straighten and proceed away from the displaced vertex 12 (following the same or substantially the same path as the navigation path 2′ resulting from the modification in block 104) until turning towards the second location 6 at a position which lies directly between the original vertex 10 and the second location 6. The navigation path 2″ can then proceed towards the second location 6 (following the same or substantially the same path as the navigation path 2 obtained in block 102).

FIG. 3 illustrates an example of smoothing the section 14 of the navigation path 2″ which passes via the displaced vertex 12, as per block 106 of the method 100. Smoothing this section 14 can comprise converting the section 14 into three or more segments 18A, 18B, 18C. Adjacent segments (e.g., 18A, 18B and 18B, 18C) can be contiguous. Adjacent segments (e.g., 18A, 18B and 18B, 18C) are angled relative to each other. The reflex angle 20A between adjacent segments 18A, 18B (likewise the reflex angle 20B between adjacent segments 18B, 18C) is smaller than the reflex angle 22 of the navigation path 2′ over the displaced vertex 12. The curved path section 16 comprises these three or more segments 18A, 18B, 18C. Thus, by smoothing the section 14 of the navigation path 2′, it is meant that the corresponding section of the navigation path 2″ (the curved path section 16) becomes smoother, not necessarily that it is smooth. The smoothing causes smaller changes in the orientation of the path more frequently. The one displaced vertex 12 can be converted into multiple vertices lying along the curved path section 16.

FIG. 4 schematically illustrates an example of how the section 14 of the navigation path 2′ which is to be smoothed is determined.

In this example the displaced vertex 12 is displaced along an angle bisector 28 of the section of the navigation path 2 over the original vertex 10.

The section 14 of the navigation path 2′ which passes via the displaced vertex 12 is taken to begin at a first waypoint 24 and to end at a second waypoint 26. Both the first and second waypoints 24, 26 lie on the navigation path 2′. The first waypoint 24 is located at an intersection of the navigation path 2′ with a perpendicular 30 to the angle bisector 28 of the path over the original vertex 10. The second waypoint 26 is also located at a (different) intersection of the navigation path 2′ with the perpendicular 30. The first waypoint 24 is located on the section of the navigation path 2′ leading to the displaced vertex 12 and the second waypoint is located on a section of the navigation path 2′ leading from the displaced vertex 12. The perpendicular 30 intersects the angle bisector 28 of the path over the original vertex 10 at a displacement from the original vertex 10 which is equal (in magnitude) and opposite (in direction) to the displacement of the displaced vertex 12 from the original vertex 10.

The magnitude (d) of the displacement of the displaced vertex 12 and the original vertex 10 can be dependent upon a turn angle (θ) and on linear and angular speed constraints (vₗᵢₙ, and v_{ang} for the turn angle. The turn angle refers to a change in an orientation of the navigation path 2 over the original vertex 10. Because the magnitude (d) of the displacement is small compared to the length of the line segment leading to the displaced vertex 12, the change in an orientation of the navigation path 2 over the original vertex 10 is approximately equal to change in an orientation of the navigation path 2′ over the displaced vertex 12.

A vehicle for which the navigation path 2″ is to be provided has motion parameters such as centre of gravity and friction of wheels. As a result of such motion parameters, there are linear and angular speed constraints (vₗᵢₙ and v_{ang}) for a given turn angle (θ).

A radius of curvature possible at the limit of these constraints can be given by:

$$r = \frac{{v}_{lin}}{{v}_{ang}}$$

Thus, a curve length (C) for a given turn angle (θ) accounting for these constraints can be given by:

$$C = 2 π r \frac{θ}{2 π} = \frac{{v}_{lin}}{{v}_{ang}} θ$$

The length of the curved path section 16 can be approximated by:

$$\frac{d}{ω cos ( \frac{π - θ}{2} )}$$

where, ωis a revising ratio. ωis used to correct for a departure between the curved path section 16 and the section of the navigation path 2 obtained in block 102 which it ultimately replaces. For example, ωcould be set as:

$$1 + \frac{1}{π + θ}$$

Therefore, to reduce the length of the curved path section 16, the length of the curved path section 16 should be set equal to the calculated curve length (C). As a result, the magnitude (d) of the displacement of the displaced vertex 12 and the original vertex 10 can be given by:

$$d = ω C cos ( \frac{π - θ}{2} ) = ω θ \frac{{v}_{lmax}}{{v}_{a max}} cos ( \frac{π - θ}{2} ) .$$

The smoothing of this thusly determined section 14 of the navigation path 2′ can be implemented by an interpolation between the first and second waypoints 24, 26. For example, the curved path section 16 can be formed by a spline, such as a cubic spline, between at least the first waypoint 24, the original vertex 10, and the second waypoint 26. Alternatively, the curved path section 16 could comprise a Bézier curve having at least the first waypoint 24, the displaced vertex 12, and the second waypoint 26 as control points.

By way of an illustrative example, the equation of a quadratic Bézier curve is given by:

B(t)=(1−t)²P₀+2t(1−t)P₁₊t²P₂, t∈[0,1]

It can therefore be seen that:

$${P}_{1} = 2 B ( 0.5 ) - \frac{{P}_{0} + {P}_{2}}{2}$$

P₀ can be set as the control point corresponding to the first waypoint 24, P₁ can be set as the control point corresponding to the displaced vertex 12, and P₂ can be set as the control point corresponding to the second waypoint 26.

By selecting a coordinate system in which the y-axis coincides with the angle bisector 28 and the x-axis coincides with the perpendicular 30 to the angle bisector 28, P₀ and P₂ are on the x-axis and P₁ is on the y-axis since the first and second waypoints 24, 26 are symmetric about the displaced vertex 12.

P₁(x,y) is therefore given by:

$$\{ \begin{matrix}x = 0 \\ y = 2 {y}_{B ( 0.5 )}\end{matrix}$$

Thus, it can be seen that if:

γ_{B(}0.5)=d

then the quadratic Bézier curve passes through the original vertex 10 at B(0.5).

In some examples, the curved path section 16 may also be formed by a circular arc between the first waypoint 24 and the second waypoint 26 and having the calculated curve length (C).

The multiple vertices lying along the curved path section 16 shown in FIG. 3 may be points on the curve which is calculated under the foregoing interpolation methods.

Although in the foregoing, examples have focused on a navigation path 2 obtained in block 102 of the method 100 which has one original vertex 10, it is to be appreciated that a navigation path 2 obtained in block 102 of the method 100 can comprise a plurality of original vertices 10A, 10B. An example of such a navigation path 2 is illustrated in FIG. 5.

In the example of FIG. 5 the two locations 4, 6 are separated by the plurality of obstacles 8A, 8B. The navigation path 2 obtained in block 102 of the method 100 can comprise a sequence of desired positions which enable a continuous motion that connects the two locations 4, 6 while avoiding collision with both obstacles 8A and 8B.

At the first original vertex 10A the orientation of the navigation path 2 changes. The first original vertex 10A represents a point at which the navigation path 2 turns towards the second original vertex 10B, having proceeded prior to this point in a direction from a first location 4 which avoids collision with the first obstacle 8A.

At the second original vertex 10B the orientation of the navigation path 2 changes. The second original vertex 10B represents a point at which the navigation path 2 turns towards the second location 6, having proceeded prior to this point in a direction from the first original vertex 10A which avoids collision with the second obstacle 8B.

In accordance with block 104 of the method 100 the navigation path 2 is modified to produce the navigation path 2′. The navigation path 2′ comprises a plurality of displaced vertices 12A, 12B with ones of the plurality of displaced vertices 12A, 12B being displaced from respective ones of the plurality of original vertices 10A, 10B.

A first displaced vertex 12A is displaced from a first original vertex 10A in a direction away from a part of the first obstacle 8A which is nearest to the first original vertex 10A.

A second displaced vertex 12B is displaced from the second original vertex 10B in a direction away from a part of the second obstacle 8B which is nearest to the second original vertex 10B.

The ones of the plurality of displaced vertices 12A, 12B are displaced in a direction away from a nearest obstacle to respective ones of the plurality of the original vertices 10A, 10B. It is to be appreciated that, for example, the displacement of the first displaced vertex 12A from the first original vertex 10A, while away from the first obstacle 8A (nearest to the first original vertex 10A), may be towards the second obstacle 8B (not nearest to the first original vertex 10A). Likewise, the displacement of the second displaced vertex 12B from the second original vertex 10B, while away from the second obstacle 8B (nearest to the second original vertex 10B), may be towards the first obstacle 8A (not nearest to the second original vertex 10B).

As shown in FIG. 5, the navigation path 2′ comprises a line segment between the first location 4 and the first displaced vertex 12A, a line segment between the first displaced vertex 12A and the second displaced vertex 12B, and a line segment between the second displaced vertex 12B and the second location 6.

In other examples the navigation path 2′ may share line segments with the navigation path 2, diverging from the navigation path 2 at a point before the first original vertex 10A to head towards the first displaced vertex 12A and rejoining the navigation path 2 at a point after the second original vertex 10B. Optionally, the navigation path 2′ may rejoin the navigation path 2 at a point after the first original vertex 10A and diverge from the navigation path 2 at a point before the second original vertex 10B to head towards the second displaced vertex 12B.

In accordance with block 106 of the method 100, sections 14A, 14B of the navigation path 2′ which respectively pass via the displaced vertices 12A, 12B are smoothed to form curved path sections 16A, 16B in the navigation path 2″. A first section 14A of the navigation path 2′ which passes via the first displaced vertex 12A is smoothed to form a first cured path section 16A in the navigation path 2″ and a second section 14B of the navigation path 2′ which passes via the second displaced vertex 12B is smoothed to form a second curved path section 16B in the navigation path 2″. The first curved path section 16A comes no closer to the first obstacle 8A than the first original vertex 10A. The second curved path section 16B comes no closer to the second obstacle 8B than the second original vertex 10B. In the example shown, the first curved path section 16A makes its closest approach to the first obstacle 8A at a position of the first original vertex 10A and the second curved path section 16B makes its closest approach to the second obstacle 8B at a position of the second original vertex 10B.

While the displacement of a displaced vertex 12 from the original vertex 10 may be towards the second obstacle 8B (or any other obstacle which is not the nearest obstacle to the original vertex 10) the positioning of the displaced vertex 12 should still ensure that the navigation path 2″ avoids collision with the second obstacle 8B or any other obstacle. FIG. 6 illustrates an example in which the navigation path 2 obtained in block 102 of the method 100 comprises a segment, following the original vertex 10, which runs between two proximate obstacles 8A, 8B.

In the example of FIG. 6 the displaced vertex 12 is displaced from the original vertex 10 in a direction which is opposite to the heading of the navigation path 2 after the original vertex 10. The section of the modified navigation path 2′ which passes via the displaced vertex 12 and is to be smoothed ends at the original vertex 10. Thus, the original vertex 10 forms the second waypoint 26. The curved path section 16 can be formed by an interpolation between a first waypoint 24 on the modified navigation path 2′ and the original vertex 10.

The position of the first waypoint 24 can be based on the calculated curve length (C) referenced in relation to FIG. 4 above. The position of the first waypoint 24 may be selected so that the curved path section 16 has a length equal to the calculated curve length (C).

In some examples the magnitude (d) of the displacement of the displaced vertex 12 from the original vertex 10 can be iterated through a set of values (from 0 up to a value equal to the calculated curve length (C)), until the curved path section 16 by given magnitude (d) of the displacement is approximately equal to the calculated curve length (C).

More generally, the displaced vertex 12 is displaced in a direction such that, when the section 14 of the navigation path 2′ over the displaced vertex 12 is smoothed, the resultant curved path section 16 avoids a collision with the second obstacle 8B. In some examples, the resultant curved path section 16 does not come too close to the second obstacle 8B. The displaced vertex 12A may be displaced in a direction such that no part of the navigation path 2′, or at least no parts of the navigation path 2′ aside from the section 14A, comes too close to the second obstacle 8B. “Too close” can refer to being closer to the second obstacle 8B than a distance between the original vertex 10 and the first obstacle 8A (the obstacle nearest to the original vertex 10) or closer to the second obstacle 8B than the width of a vehicle to which the navigation path 2″ is to be provided and/or a safety threshold around the second obstacle 8B.

While FIGS. 5 and 6 show examples of navigation paths 2 which comprise one original vertex 10 in order to bypass one obstacle 8, in some examples such as those of FIG. 7 and FIG. 8, a navigation path 2 as obtained in block 102 of the method 100 comprises two or more original vertices 10A, 10B to bypass a single obstacle 8.

Where these two or more original vertices 10A, 10B are sufficiently distant from one another, an interpolation method as described in relation to FIG. 4 above could be used to generate respective curved path sections in the navigation path 2″, for example.

However, where these two or more original vertices 10A, 10B are substantially proximate, there may not be sufficient space for curved path sections for each of the original vertices 10A, 10B in accordance with the method described in relation to FIG. 4.

The second original vertex 10B can be considered substantially proximate to the first original vertex 10A if a second waypoint derived from the first original vertex 10A in the manner described in relation to FIG. 4 above would be intermediate of a displaced vertex and first waypoint derived from the second original vertex 10B in the manner described in relation to FIG. 4 above. The second original vertex 10B can be considered substantially proximate to the first original vertex 10A if a first waypoint derived from the second original vertex 10B in the manner described in relation to FIG. 4 above would be intermediate of a displaced vertex and second waypoint derived from the first original vertex 10A in the manner described in relation to FIG. 4 above.

FIG. 7 shows one example of how to form a curved path section 16 in the navigation path 2″ when two or more original vertices 10A, 10B are proximate.

In this example the navigation path 2 obtained in block 102 of the method 100 comprises a first original vertex 10A and a second original vertex 10B, which is proximate to the first original vertex 10A.

The section of the navigation path 2 which bypasses the obstacle 8 comprises both the first original vertex 10A and the second original vertex 10B.

The corresponding section of the navigation path 2′ resulting from the modification in block 104 of the method 100 comprises one displaced vertex 12. That is, the navigation path 2′ bypasses the obstacle 8 using the one displaced vertex 12. This one displaced vertex 12 can lie on an angle bisector 32 of the path via both of the original vertices 10A, 10B. This one displaced vertex 12 can be displaced from a point along the angle bisector 32 at which the line segment of the navigation path 2 which heads to the original vertex 10A and the line segment of the navigation path 2 which heads away from the original vertex 10B would intersect if both were prolonged.

The section 14 of the navigation path 2′ which passes via this one displaced vertex 12 can be smoothed to form the curved path section 16 in the navigation path 2″. The smoothing can be implemented using an interpolation method as described in relation to FIG. 4, for example. The resultant curved path section 16 may pass through the point along the angle bisector 32 at which the line segment of the navigation path 2 which heads to the original vertex 10A and the line segment of the navigation path 2 which heads away from the original vertex 10B would intersect if both were prolonged.

FIG. 8 shows another example of how to form a curved path section 16 in the navigation path 2″ when two or more original vertices 10A, 10B are proximate.

In this example the navigation path 2 obtained in block 102 of the method 100 comprises a first original vertex 10A and a second original vertex 10B, which is proximate to the first original vertex 10A.

The section of the navigation path 2 which bypasses the obstacle 8 comprises both the first original vertex 10A and the second original vertex 10B.

The navigation path 2′ resulting from the modification in block 104 of the method 100 comprises two displaced vertices 12A and 12B as respective counterparts to the first and second original vertices 10A, 10B.

A first displaced vertex 12A is displaced from the first original vertex 10A in a direction away from a part of the obstacle 8 which is nearest to the first original vertex 10A.

A second displaced vertex 12B is displaced from the second original vertex 10B in a direction away from a part of the obstacle 8 which is nearest to the second original vertex 10B.

A section 34 of the navigation path 2′ which passes via both of the displaced vertices 12A, 12B is smoothed in order to form the curved path section 16 in the navigation path 2″, That is, the navigation path 2′ bypasses the obstacle 8 using the two displaced vertices 12A, 12B.

The smoothing of the section 34 of the navigation path 2′ can be implemented by an interpolation between first and second waypoints 24, 26, marking the beginning and end of the section 34. For example, the curved path section 16 can be formed by a spline, such as a cubic spline, between at least the first waypoint 24, the first original vertex 10A, the second original vertex 10B, and the second waypoint 26. Alternatively, the curved path section 16 could comprise a Bézier curve having at least the first waypoint 24, the first displaced vertex 12A, the second displaced vertex 12B, and the second waypoint 26 as control points.

By way of an illustrative example, the equation of cubic Bézier curve is given by:

B(t)=(1−t)³P₀+3t(1−t)³P₁+3t²(1−t)P₂+t³P₃, t∈[0,1]

The control points of the cubic Bézier curve can be selected such that it passes through the two original vertices 10A, 10B. That it, the first original vertex 10A is located at B(t₁) and the second original vertex 10B is located at B(t₂).

The first and second waypoints 24, 26, providing the control points P₀ and P₃ respectively, and the first and second displaced vertices 12A, 12B, providing the control points P₁ and P₂ respectively, are positioned according to the following relationship:

−(xₚ_{₀}+xₚ_{₁})=xₚ_{₂}+xₚ_{₃}

in a coordinate system selected such that the two original vertices 10A, 10B are located on the x-axis and symmetrically arranged about the y-axis.

Within this coordinate system, the first waypoint 24 is positioned at (xₚ₀, −d), the first displaced vertex 12A is positioned at (xₚ₁, d), the second displaced vertex 12B is positioned at (xₚ₂, d), and the second waypoint 26 is positioned at (xₚ₃, −d).

Thus:

0=−d(1−t)³+3dt(1−t)³P₁+3dt²(1−t)−dt³

Solving this equation gives:

$${t}_{1} = \frac{3 - \sqrt{3}}{6} , {t}_{2} = \frac{3 + \sqrt{3}}{6}$$

Since the the two original vertices 10A, 10B are symmetrical about the y-axis, then:

X_{B(t}_{₁}₎=−X_{B(t}_{₂}₎

By substituting for values of t₁ and t₂, the above-mentioned relationship between the first and second waypoint 24, 26 and the first and second displaced vertices 12A, 12B is found.

In some examples the value of d can be iterated through a set of values until length of the cubic Bézier curve is approximately equal to the calculated curve length (C).

FIG. 9A illustrates an example of a controller 202. Implementation of a controller 202 may be as controller circuitry. The controller 202 may be implemented in hardware alone, have certain aspects in software including firmware alone or can be a combination of hardware and software (including firmware).

As illustrated in FIG. 9A the controller 202 may be implemented using instructions that enable hardware functionality, for example, by using executable instructions of a computer program 208 in a general-purpose or special-purpose processor 204 that may be stored on a computer readable storage medium (disk, memory, etc.) to be executed by such a processor 204.

The processor 204 is configured to read from and write to the memory 206. The processor 204 may also comprise an output interface via which data and/or commands are output by the processor 204 and an input interface via which data and/or commands are input to the processor 204.

The memory 206 stores a computer program 208 comprising computer program instructions (computer program code) that controls the operation of the apparatus 200 when loaded into the processor 204. The computer program instructions, of the computer program 208, provide the logic and routines that enables the apparatus to perform the methods illustrated in FIG. 1. The processor 204 by reading the memory 206 is able to load and execute the computer program 208.

The apparatus 200 therefore comprises:

at least one processor 204; and

at least one memory 206 including computer program code

the at least one memory 206 and the computer program code configured to, with the

at least one processor 204, cause the apparatus 200 at least to perform:

obtaining a navigation path 2 between two locations 4, 6 which are separated by an obstacle 8, the navigation path 2 comprising an original vertex 10;

modifying the navigation path 2 to comprise a displaced vertex 12, the displaced vertex 12 being displaced from the original vertex 10 in a direction away from a part of the obstacle 8 which is nearest to the original vertex 10; and

smoothing a section 14 of the navigation path 2′ which passes via the displaced vertex 12, wherein the smoothing of the section 14 forms a curved path section 16 in the navigation path 2″, the curved path section 16 coming no closer to the obstacle 8 than the original vertex 10.

As illustrated in FIG. 9B, the computer program 208 may arrive at the apparatus 200 via any suitable delivery mechanism 210. The delivery mechanism 210 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 208. The delivery mechanism may be a signal configured to reliably transfer the computer program 208. The apparatus 200 may propagate or transmit the computer program 208 as a computer data signal.

Computer program instructions for causing an apparatus to perform at least the following or for performing at least the following:

causing obtaining of a navigation path 2 between two locations 4, 6 which are separated by an obstacle 8, the navigation path 2 comprising an original vertex 10;

causing modifying of the navigation path 2 to comprise a displaced vertex 12, the displaced vertex 12 being displaced from the original vertex 10 in a direction away from a part of the obstacle 8 which is nearest to the original vertex 10; and

causing smoothing of a section 14 of the navigation path 2′ which passes via the displaced vertex 12, wherein the smoothing of the section 14 forms a curved path section 16 in the navigation path 2″, the curved path section 16 coming no closer to the obstacle 8 than the original vertex 10.

The computer program instructions may be comprised in a computer program, a non-transitory computer readable medium, a computer program product, a machine readable medium. In some but not necessarily all examples, the computer program instructions may be distributed over more than one computer program.

Although the memory 206 is illustrated as a single component/circuitry it may be implemented as one or more separate components/circuitry some or all of which may be integrated/removable and/or may provide permanent/semi-permanent/dynamic/cached storage.

Although the processor 204 is illustrated as a single component/circuitry it may be implemented as one or more separate components/circuitry some or all of which may be integrated/removable. The processor 204 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIG. 1 may represent steps in the method 100 and/or sections of code in the computer program 208. The illustration of a particular order to the blocks does not necessarily imply that there is a required or preferred order for the blocks and the order and arrangement of the block may be varied. Furthermore, it may be possible for some blocks to be omitted.

The apparatus 200 of FIG. 9A may be or may comprise the controller 202 or may be or comprise any computer or machine capable of reading the computer program 208 from the delivery mechanism 210 and running that computer program 208.

The apparatus 200 may further comprise a camera or other sensors capable of observation of a scene comprising the two locations 4, 6 and the at least one obstacle 8 between them.

The apparatus 200 may further comprise at least one transceiver. The at least one transceiver may comprise any suitable means for receiving and/or transmitting information. Information that could be transmitted or received can comprise: data of the observed scene; data of the salient features of the observed scene; a calculated navigation path 2. The at least one transceiver may comprise one or more transmitters and/or receivers. The at least one transceiver may enable a wireless connection between the apparatus 200 and a remote device. The wireless connection could be via short-range radio communications such as Wi-Fi or Bluetooth, for example, or over long-range cellular radio links or any other suitable type connection.

It is to be appreciated that the apparatus 200 may comprise any suitable means for performing the functions hereinbefore described.

Consequently, in some examples, the apparatus 200 comprises means for:

obtaining a navigation path 2 between two locations 4, 6 which are separated by an obstacle 8, the navigation path 2 comprising an original vertex 10;

modifying the navigation path 2 to comprise a displaced vertex 12, the displaced vertex 12 being displaced from the original vertex 10 in a direction away from a part of the obstacle 8 which is nearest to the original vertex 10; and

smoothing a section 14 of the navigation path 2′ which passes via the displaced vertex 12, wherein the smoothing of the section 14 forms a curved path section 16 in the navigation path 2″, the curved path section 16 coming no closer to the obstacle 8 than the original vertex 10.

Where a structural feature has been described, it may be replaced by means for performing one or more of the functions of the structural feature whether that function or those functions are explicitly or implicitly described.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

In some examples the apparatus 200 may be, or be comprised in, a vehicle control system 302 as shown in FIGS. 10A and 10B. The vehicle control system 302 may run the computer program 208.

The vehicle control system may be on-board a vehicle 300 (as shown in FIG. 10A) or may be remote from the vehicle 300 (as shown in FIG. 10B) and configured to communicate data such as the navigation path 2″ to the vehicle 300.

The vehicle control system 302 which is located remotely from the vehicle 300 may be a control station. The control station may include various hardware and software components configured for communication with and control over the vehicle. The control station may include computers, human-machine interfaces, and other components which may be used for controlling observing and planning, controlling movement, uploading mission commands, receiving and presenting status information (e.g., vehicle status, missions status, or the like, as well as various combinations thereof), monitoring live video streams, or the like, as well as various combinations thereof. The control station may include various other elements, support various other functions and capabilities, or the like, as well as various combinations thereof.

Regarding communication between the vehicle 300 and the control station (or other vehicle control system 302 which is located remotely from the vehicle 300), an access architecture may be applied, e.g. a radio access architecture based on long term evolution advanced (LTE Advanced, LTE-A) or new radio (NR, 5G), without restricting the embodiments to such an architecture, however. Embodiments may also be applied to other kinds of communications networks having suitable means for adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The system of the vehicle 300 and the vehicle control system 302 shown in FIG. 10B may be only an example of a part of a radio access system and in practice, the system may comprise a plurality of (e/g)NodeBs, the vehicle 300 may have an access to a plurality of radio cells during mission and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

In certain embodiments, as the current architecture in LTE networks is fully distributed in the radio and fully centralized in the core network, the low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as computers, laptops, smartphones, tablets and sensors. MEC provides a distributed computing environment for application and service hosting. It also has the ability to store and process, control, observe and control movement, upload mission commands, receive and present status information (e.g., vehicle status, missions status, or the like, as well as various combinations thereof), monitor live video streams, or the like, as well as various combinations thereof, control route information like progress of and trigger to return in close proximity for faster response time, and communicate changes and necessary guidance in the routing. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The navigation path 2″ could be used to control motion of for example, and without limitation: motor vehicles including cars, buses, motorcycles, off-road vehicles, and trucks; mobile robots; autonomous robots; drones or other unmanned aerial vehicles; autonomous underwater vehicles; remote controlled vehicles or toy vehicles; planetary rovers; or other manned or unmanned vehicles or simulated vehicles in a simulation such as a video game or tutorial.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1.-19. (canceled)

20. An apparatus comprising
at least one processor; and at least one memory including computer program code;
the at least one memory and the computer program code configured to, with the at least one processor, cause the apparatus at least to perform:
obtain a navigation path between two locations which are separated by an obstacle, the navigation path comprising an original vertex;
modify the navigation path to comprise a displaced vertex, the displaced vertex being displaced from the original vertex in a direction away from a part of the obstacle which is nearest to the original vertex; and
smooth a section of the navigation path which passes via the displaced vertex, wherein the smoothing of the section forms a curved path section in the navigation path, the curved path section coming no closer to the obstacle than the original vertex.

21. An apparatus as claimed in claim 20 wherein the curved path section makes its closest approach to the obstacle at a position of the original vertex.

22. An apparatus as claimed in claim 20 wherein the navigation path comprises a sequence of desired positions which enable a continuous motion that connects the two locations.

23. An apparatus as claimed in claim 20 wherein, prior to the modification, the navigation path comprises a substantially shortest path between the two location while avoiding collision with the obstacle.

24. An apparatus as claimed in claim 20 wherein a distance between the displaced vertex and the part of the obstacle which is nearest to the original vertex is greater than a distance between the original vertex and the part of the obstacle which is nearest to the original vertex, and the original vertex is intermediate to the displaced vertex and the part of the obstacle which is nearest to the original vertex.

25. An apparatus as claimed in claim 20 wherein the smoothing of the section of the navigation path which passes via the displaced vertex comprises converting the section into three or more segments, adjacent segments being angled relative to each other, the reflex angle between the adjacent segments being smaller than the reflex angle of the navigation path over the displaced vertex.

26. An apparatus as claimed in claim 25 wherein the curved path section comprises the three or more segments.

27. An apparatus as claimed in claim 20 wherein the magnitude of the displacement of the displaced vertex from the original vertex is dependent on a turn angle and on linear and angular speed constraints for the turn angle.

28. An apparatus as claimed in claim 20 wherein the navigation path, prior to modification, comprises a plurality of original vertices.

29. An apparatus as claimed in claim 28 wherein the navigation path is modified to comprise a quantity of displaced vertices which is less than the plurality of original vertices.

30. An apparatus as claimed in claim 28 wherein the navigation path is modified to comprise a plurality of displaced vertices, ones of the plurality of displaced vertices being displaced from respective ones of the plurality of original vertices.

31. An apparatus as claimed in claim 30 wherein:
a first of the plurality of displaced vertices is displaced from a first of the plurality of original vertices in a direction away from a part of the obstacle which is nearest to the first of the plurality of original vertices,
a second of the plurality of displaced vertices is displaced from a second of the plurality of original vertices in a direction away from a part of the obstacle which is nearest to the second of the plurality of original vertices, and
a section of the navigation path which passes via both the first and second of the plurality of displaced vertices is smoothed in order to form the curved path section in the navigation path.

32. An apparatus as claimed in claim 20 wherein the displaced vertex is displaced along an angle bisector of a section of the navigation path over the original vertex.

33. An apparatus as claimed in claim 32 wherein the section of the navigation path which passes via the displaced vertex begins at a first waypoint and ends at a second waypoint,
the first waypoint being at an intersection of the navigation path leading to the displaced vertex with a perpendicular to the angle bisector of the section of the navigation path over the original vertex,
the second waypoint being at an intersection of the navigation path leading from the displaced vertex with the perpendicular to the angle bisector of the section of the navigation path over the original vertex,
the perpendicular to the angle bisector intersecting the angle bisector at a displacement from the original vertex which is equal and opposite to the displacement of the displaced vertex from the original vertex.

34. An apparatus as claimed in claim 20 wherein the displaced vertex is displaced in a direction such that, when the section of the navigation path which passes via the displaced vertex is smoothed, the curved path section avoids a collision with a second obstacle.

35. A vehicle control system comprising the apparatus of claim 20, the navigation path being for controlling motion of a vehicle.

36. A vehicle comprising the vehicle control system of claim 35.

37. A method comprising:
obtaining a navigation path between two locations which are separated by an obstacle, the navigation path comprising an original vertex;
modifying the navigation path to comprise a displaced vertex, the displaced vertex being displaced from the original vertex in a direction away from a part of the obstacle which is nearest to the original vertex; and
smoothing a section of the navigation path which passes via the displaced vertex, wherein the smoothing of the section forms a curved path section in the navigation path, the curved path section coming no closer to the obstacle than the original vertex.

38. A method of claim 37 wherein the curved path section makes its closest approach to the obstacle at a position of the original vertex.

39. A non-transitory computer readable medium/computer product/machine readable medium, comprising instructions stored thereon for performing at least the following:
causing obtaining of a navigation path between two locations which are separated by an obstacle, the navigation path comprising an original vertex;
causing modifying of the navigation path to comprise a displaced vertex, the displaced vertex being displaced from the original vertex in a direction away from a part of the obstacle which is nearest to the original vertex; and
causing smoothing of a section of the navigation path which passes via the displaced vertex, wherein the smoothing of the section forms a curved path section in the navigation path, the curved path section coming no closer to the obstacle than the original vertex.
